(19) United States
(12) Patent Application Publication
(10) Pub. No.: US 2017/0303712 A1
(43) Pub. Date: Oct. 26, 2017

(54) PORTABLE CAPSULE PERCOLATOR DRINKING CUP

(71) Applicant: Arie Pisarevsky, Modiin (IL)

(72) Inventor: Arie Pisarevsky, Modiin (IL)

(21) Appl. No.: 15/209,826

(22) Filed: Jul. 14, 2016

Related U.S. Application Data
(60) Provisional application No. 62/326,916, filed on Apr. 25, 2016.

(51) Int. Cl. A47G 19/22; B65D 47/08; A47J 31/00; A47J 31/40; B65D 85/804; B65D 81/38

(52) U.S. Cl. CPC A47G 19/2272; B65D 85/8043; B65D 81/3869; A47J 31/005; A47J 31/407; B65D 47/08

(57) ABSTRACT

The disclosure herein relates to a portable capsule percolator with a drinking cup. In particular, the disclosure relates to a portable and easy to use capsule percolator, operable, using capsules readily available on the market, for making a desired percolated beverage such as coffee, tea, vegetarian drinks and the like, on the go, at the office, while travelling and more specifically, whenever or wherever such a drink is desired. The portable capsule percolator is operable by a pressure differential mechanism without the need of a power source. The portable capsule percolator includes an air-extracting mechanism operable to extract air from a first internal space and a sealing mechanism associated with the flask lid section configured to let outside air into a second internal space generating the pressure differential, activating the percolating process by pushing the liquid through a beverage capsule into a percolating section.

### CROSS-REFERENCE TO RELATED APPLICATIONS

This application claims the benefit of priority from U.S. Provisional Patent Application No. 62/326,916, filed Apr. 25, 2016, the contents of which are incorporated by reference in their entirety.

### FIELD OF THE INVENTION

The disclosure herein relates to a portable capsule percolator with a drinking cup. In particular, the disclosure relates to a portable and easy to use capsule percolator operable, using readily available capsules, for making a desired percolated beverage such as coffee, tea, vegetarian drinks and the like, on the go, at the office, while travelling and more. The portable capsule percolator is operable by a pressure differential mechanism without the need of a power source. The portable capsule percolator includes an air-extracting mechanism operable to extract air from a first internal space and a sealing mechanism associated with the flask lid section configured to let outside air into a second internal space generating the pressure differential, activating the percolating process by pushing the liquid through a beverage capsule into a percolating section.

### BACKGROUND OF THE INVENTION

The invention of coffee pods and capsules have revolutionized coffee drinking and have fueled the increasing popularity in the past years of one of the most distinctive beverages available. A coffee pod or capsule is basically an amount of coffee held within a small container, where the container is then entered into a coffee maker and brewed. The simplicity and ease of use of a single shot of coffee brewed with little to no cleanup is appealing to consumers all over the world. The differences in the two lie mostly in the construction of the pod/capsule. Capsules are usually a plastic or aluminum container top sealed with an aluminum or plastic foil which holds the coffee grounds and filter within. A coffee pod is simply a “bag” that is constructed from a coffee filter that is filled with coffee grounds. No matter how you cut it, be it a coffee pod or capsule you are simply pushing water through coffee grounds to create coffee. The systems used for capsules and pods are different systems and even with capsules, each system is commonly associated with a capsule housing according to the relevant capsule dimensions, and therefore are not interchangeable with other systems.

The usage of capsules expanded into to a variety of beverages of tea, coffee, chocolate, cappuccino, vegetarian drinks and more capsules and a dedicated machine are growing in their popularity, becoming increasingly widespread and provide something for every taste and occasion.

There are a number of techniques in brewing coffee. Percolating is one such common technique and as stated, percolating while using a beverage capsule expanded to a variety of drinks. Specifically, brewed coffee refers to any method of coffee preparation where hot water comes in contact with coffee grounds for an extended period of time. Percolation involves a solvent passing through a permeable substance especially for extracting a soluble constituent. In the case of coffee-brewing the solvent is water, the permeable substance is the coffee grounds, and the soluble constituents are the chemical compounds that give coffee its color, taste, aroma, and stimulating properties. In simple terms, if coffee percolates, or if one is percolating it, it is made in a container in which hot water passes through a beverage powder

In 2015, Americans who drink coffee consumed about 1.7 cups a day on average, up from 1.4 cups a decade earlier, according to an estimate by New York-based researcher Study-Logic.

Generally, coffee is best when freshly prepared. To prepare fresh percolated coffee typically requires a power source to heat water and to maintain a pressure differential which drives the hot water through the coffee. There is no way to make percolated coffee in a handheld drinking cup.

There is a need for a portable capsulate percolating device that conveniently provides ‘on the go’ ability to prepare easily freshly made beverages such as coffee, but also including tea, vegetarian drinks and the like, without the need of a power source to continually keep the liquid at a desired temperature.)

The invention below addresses the above-described needs.

### SUMMARY OF THE INVENTION

It is an advantage of the current disclosure that it may improve preservation of the freshness, taste and natural appearance of a percolated beverage such as coffee, tea, vegetarian drinks and the like using a portable drinks percolator configured to use a pressure differential mechanism to activate the percolating without the need of a power source. The portable drinks percolator includes an air-extracting mechanism operable to extract air from an upper internal space formed by a percolating section and an upper cap assembly section. The percolator further includes a sealing mechanism associated with a flask lid section comprising a body sealable aperture configured to let outside air into a first internal space formed by the flask lid section and a liquid reservoir section, thereby activating the beverage percolating process.

Aspects of the disclosure present a portable capsule percolator with a drinking cup for making a desired beverage when and whenever desired, on the go, at the office, when travelling and the like. The portable drinks percolator comprising: a liquid reservoir section comprising an insulated container suitable for retaining a portion of a liquid, the liquid reservoir section further comprises a flask lid section forming a lower internal space; a percolator section comprising a beverage receptacle reservoir section configured to receive beverage infused liquid percolated through a beverage capsule of a desirable flavor; and an upper cap assembly section coupleable with the beverage receptacle reservoir section forming a second internal space, the upper cap assembly section comprising an air-extracting device operable to extract air from the second internal space,

wherein the portable drinks percolator is operable to create a pressure differential between the second internal space and the first internal space thereby driving continually the liquid from the liquid reservoir section through the beverage capsule into the beverage receptacle reservoir section.

As appropriate, the upper cap assembly section further comprises a sealable liquid outlet and a lip to facilitate drinking therefrom.

As appropriate, the percolator section further comprises: a housing for the beverage capsule, the beverage capsule having a first face and a second face; at least one capsule puncture pin configured to puncture the first face of the beverage capsule; a housing flow tube comprising a spout cover extending into the beverage receptacle reservoir section, the housing flow tube operable to allow flow through the beverage capsule onto the beverage receptacle reservoir section through at least one slot of the spout cover. Additionally, the housing flow tube comprises the at least one capsule puncture pin.

As appropriate, the percolator section further comprises a non-return valve to prevent beverage leakage into the liquid reservoir section.

As appropriate, the flask lid section comprises: a flask flow tube extending through the flask lid section into the liquid reservoir section; a second puncture pin configured to puncture the second face of the beverage capsule; and body sealable aperture comprising a first sealing element operable to allow air passage into the lower internal space (the first internal space) at the top of the liquid reservoir section to form the pressure differential. Additionally, the body sealable aperture uses a sealing mechanism operable to disengage the first sealing element. Variously, the sealing mechanism is selected from a group including of: a push button, a sealing ring, a sealing handle and combinations thereof.

As appropriate, the pressure differential is generated by activating the air-extracting device to extract air from the upper internal space (the second internal space) and further allowing outside air into the lower internal space via said sealing mechanism thereby activating beverage percolation. Accordingly, the first sealing element comprises an air-tight seal made of a rubberized material configured to fit tightly into the body sealable aperture.

As appropriate, the upper cap assembly section comprises: an upper cap body comprising the lip and an air-extracting chamber configured to incorporate the air-extracting device; a sealable outlet having an outlet sealable aperture and a second sealing element; and a closure lid secured onto the lip and operable to cover tightly the outlet sealable aperture. Additionally, the closure lid further comprises: at least one hinge attached to the upper cap body enabling the closure lid to rotate thereabout, and further to disengage from the outlet sealable aperture, thereby uncovering the outlet sealable aperture to allow air access to enable drinking.

Optionally, the second sealing element comprises an air-tight seal of a rubberized material configured to fit tightly into the outlet sealable aperture.

Optionally, the air-extracting mechanism comprises an extracting plunger, an activator and a mechanical spring configured such that the activator is operable to activate the extracting plunger against the mechanical spring thereby generating linear motion to evacuate air from the upper internal space.

As appropriate, the insulated container comprises a double wall having an inner wall and an outer wall configured to inhibit conduction of heat from the lower internal space. Optionally, the insulated container comprises a double vacuum insulated wall having an inner wall and an outer wall forming a vacuum seal configured to inhibit conduction of heat from the lower internal space. Alternatively, the insulated container may include a wall of a material variously selected from a group consisting of: a transparent material, an opaque material and combinations thereof.

Additionally, the liquid reservoir section comprises a wall of a material selected variously from a group consisting of: a transparent material, an opaque material and combinations thereof.

As appropriate, the flask lid section comprises a flask lid body comprising a coupling mechanism with at least one rubberized sealing ring. Accordingly, the coupling mechanism is configured to couple the flask lid section said liquid reservoir section. Additionally, the coupling mechanism is configured to couple the flask lid section with the percolator section.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic cross-section illustration of a portable drinks percolator for preparing a fresh desirable beverage, according to one embodiment of the disclosure;

FIG. 2 is another schematic cross-section illustration of a portable drinks percolator for preparing a fresh desirable beverage, according to one embodiment of the disclosure;

FIG. 3A is a schematic exploded perspective view of the main elements of a portable drinks percolator, according to the embodiment of FIG. 1;

FIG. 3B is a schematic exploded perspective view of the main elements of a chain of interlocking liquid reservoir sections for use in certain embodiments of the current disclosure;

FIGS. 4A-B are a schematic perspective and side cross-section illustrations of a flask lid coupleable with the liquid reservoir section, according to another embodiment of the current disclosure;

FIG. 5A-B is a schematic perspective view illustration of a percolator section with/without the beverage receptacle wall, according to one embodiment of the current disclosure;

FIG. 5C is a schematic side view illustration of a percolator section without the beverage receptacle wall, according to one embodiment of the current disclosure;

FIG. 6 is a schematic exploded perspective view illustration of an upper cap assembly section of the portable drinks percolator, according to an embodiment of the current disclosure.

FIG. 7 is a schematic side cross-section illustration of a an upper cap assembly section of the portable drinks percolator, according to an embodiment of the current disclosure;

FIG. 8 is a schematic perspective view illustration of an upper cap assembly section top view illustration of a portable drinks percolator, according to an embodiment of the current disclosure; and

FIG. 9 is a schematic top view illustration of an upper cap assembly section of the portable drinks percolator, according to an embodiment of the current disclosure.

### DETAILED DESCRIPTION OF THE INVENTION

It is noted that the systems and methods of the invention herein, may not be limited in their application to the details of construction and the arrangement of the components or methods set forth in the following description or illustrated in the drawings and examples. The systems and methods of the invention may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

Accordingly, various embodiments may omit, substitute, or add various procedures or components as appropriate. For instance, it should be appreciated that the methods may be performed in an order different than described, and that various steps may be added, omitted or combined. Also, aspects and components described with respect to certain embodiments may be combined in various other embodiments. It should also be appreciated that the systems, methods, devices, and software may individually or collectively be components of a larger system, wherein other procedures may take precedence over or otherwise modify their application.

The disclosure herein relates to an apparatus associated with a portable capsule percolator with a drinking cup, comprising a capsule housing configured according to capsule dimensions. In particular, the disclosure relates to preparing a fresh beverage such as coffee, tea and the like based upon pressure differential. The beverage may be prepared, at any desirable time, as the portable drinks percolator is a self-contained unit, using an air extraction mechanism configured to extract air from the internal space of the receptacle reservoir section of the percolator section, and allowing air into the liquid reservoir when the beverage is desired.

As used herein, the apparatus of the disclosure is referred to as “a portable drinks percolator” or “a portable capsule percolator with a drinking cup”, in both cases it refers to the same product.

As used herein, a beverage capsule is used for brewing a desirable beverage such as coffee, hot chocolate, tea, soup, vegetarian or fruit flavored and is sealed in a kind of a cartridge, commonly a plastic or an aluminum container. The cartridge may have a plastic ring covered with a foil top. The inside of the beverage capsule is lined with a filter material and keeps the beverage contained while brewing. When placing such a capsule into a compatible brewer, there may be two puncturing pins that puncture the lid and the bottom of the capsule. Water, for example, flows into the foil top, extracts the beverage flavor, and out via the puncture of the plastic cup.

As used herein, rubberized material is a term used to describe any flexible, stretchable polymer coated textile or material. The coating on the material may be for various reasons including water resistance or waterproofing, or to impart non slip, grip or friction capabilities to the substrate fabric.

### The Portable Drinks Percolator:

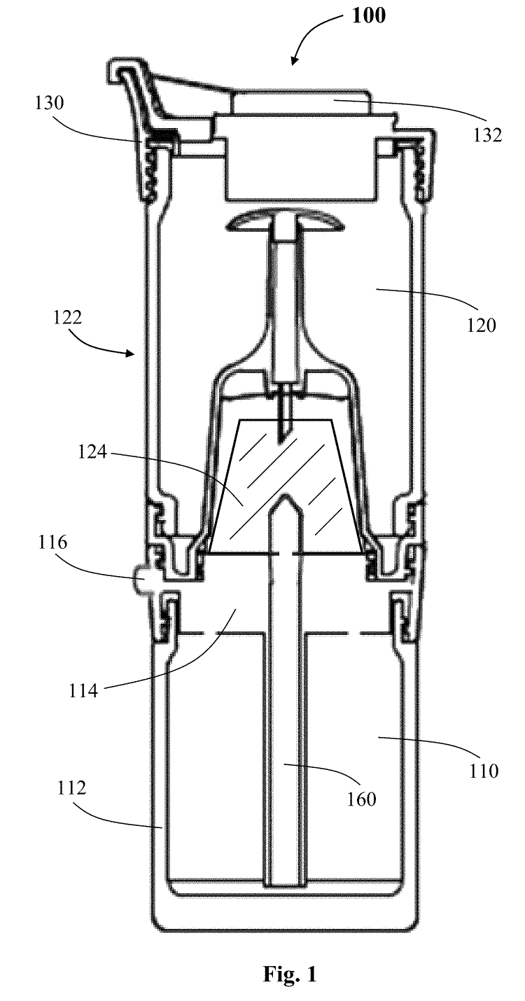

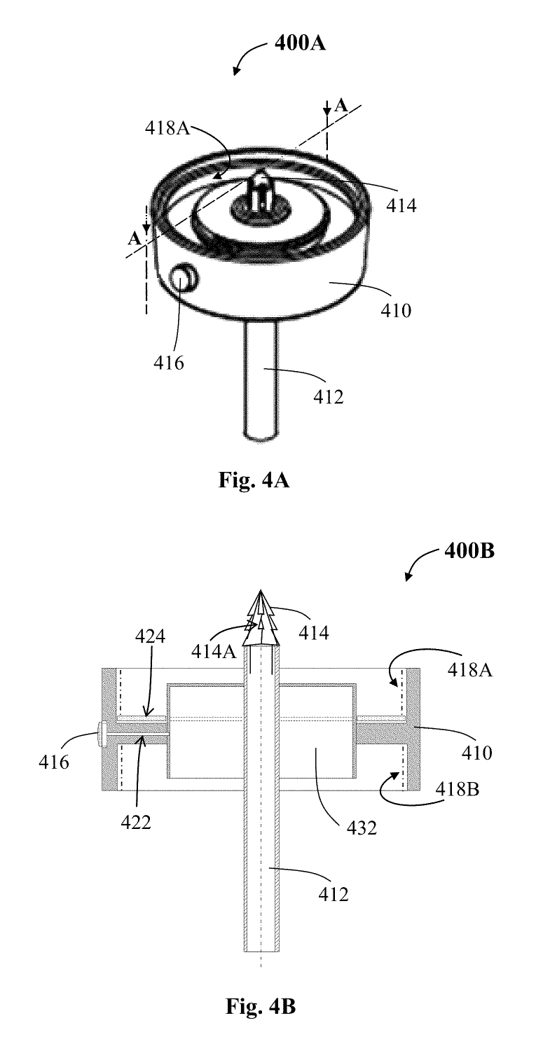

Reference is now made to FIG. 1, there is provided a schematic perspective view illustration of a portable drinks percolator, which is generally indicated at 100, for preparing a desirable beverage (coffee, tea, chocolate, soup and the like), according to one embodiment of the invention. The portable drinks percolator 100 includes a liquid reservoir section 110 comprising an insulated container 112 suitable for retaining a portion of the liquid and a flask lid section 114 forming a lower internal space, a percolator section 120 comprising a beverage receptacle reservoir section 122 configured to receive beverage infused liquid percolated through a beverage capsule 124 of a desirable flavor and an upper cap assembly section 130 comprising an air-extracting device 132, and is further coupleable with the liquid receptacle reservoir section 122, forming an upper internal space. The flask lid section 114 further comprising a sealing element 116 operable to allow air passage into the lower internal space at the top of the liquid reservoir section 110, via a body sealable aperture (see FIG. 4B, item 422 to form the pressure differential.

Optionally, the insulated container 112 of the liquid reservoir section 110 comprises a double walled container, having an inner wall and an outer wall configured to inhibit conduction of heat from the reservoir space, as described in the embodiments, hereinafter. Additionally or alternatively, the double walled container is made of opaque material.

Optionally, the double walled material is made of transparent material. As appropriate, the doubled wall material comprises insulating properties.

Optionally, the inner wall and the outer wall of the insulated container 112 form a vacuum seal for the insulated container 112 of the liquid reservoir section 110, configured to better inhibit conduction of heat therefrom.

Optionally, the insulated container 112 of the liquid reservoir section 110 comprises a solid walled container as described in the embodiments, hereinafter. Additionally or alternatively, the solid walled container is made of opaque material. Alternatively, the solid walled material is made of transparent material. As appropriate, the solid walled material comprises insulating properties.

It is noted that the flask lid section 114 may use a sealable coupling mechanism to couple with the liquid reservoir section 110 and further with the percolator section 120, as detailed in FIGS. 4A-B.

It is noted that the flask lid section 114 is further described in FIGS. 4A-B.

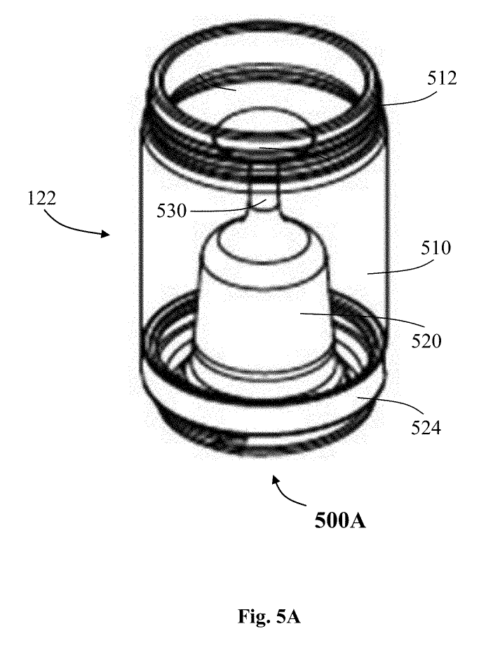

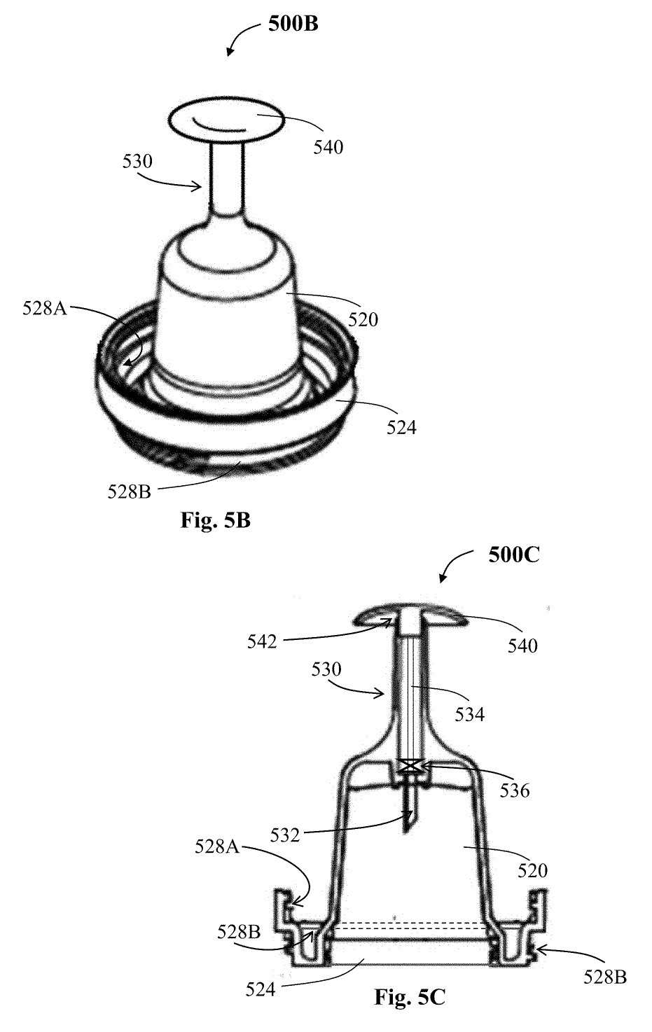

It is further noted that the percolator section 120 is fully described in FIGS. 5A-C.

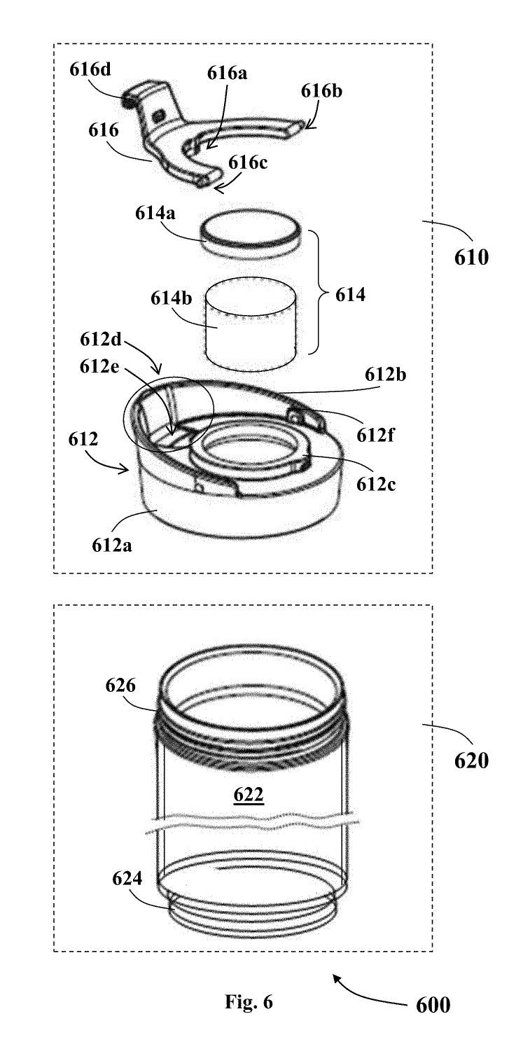

It is also noted that the upper cap assembly section 130 is fully described detailed in FIGS. 6, 7 and 8.

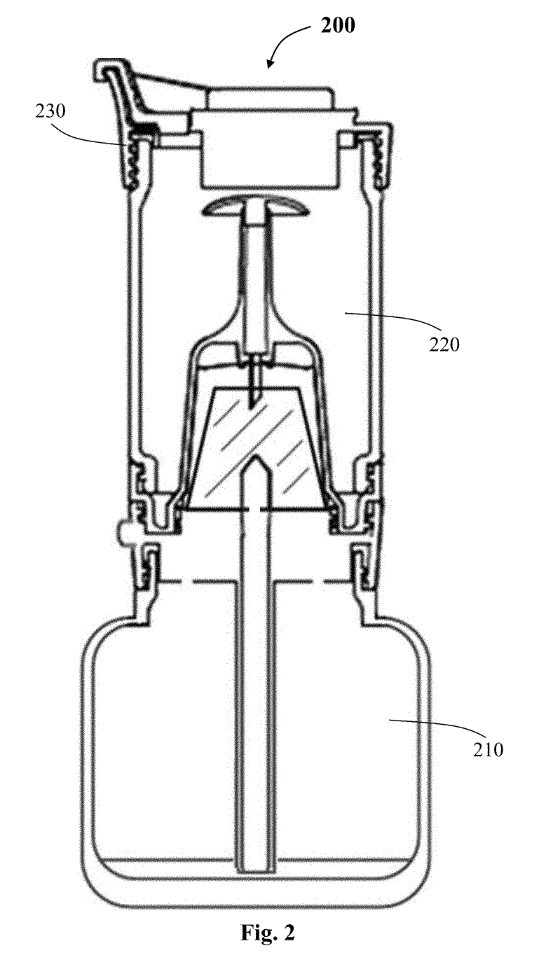

It should be appreciated that the liquid reservoir section 110 may contain sufficient amount of liquid for one cup of desirable beverage, and is presented in this embodiment by way of example only, in a non-limiting manner. Optionally, the liquid reservoir section 110 may be provided in different sizes, such as described in the embodiment of FIG. 2.

### The Liquid Reservoir:

Accordingly, as illustrated in FIG. 2, there is provided another embodiment showing a schematic perspective view illustration of a portable drinks percolator, which is generally indicated at 200, for preparing a plurality of desirable beverage servings. Similarly, as described in the embodiment described in FIG. 1, the portable drinks percolator 200 includes three major components: a liquid reservoir section 210, a percolator section 220 and an upper cap assembly section 230, but differs from FIG. 1 by the size of the liquid reservoir section 210. The liquid reservoir section 210 may contain several portions of liquid, providing the ability to prepare a plurality of glasses of the desired beverage, in sequence, depending on the size of the liquid reservoir.

In still other embodiments multiple liquid reservoir sections may be provided, each of which for containing sufficient liquid to produce a single glass of beverage. The multiple liquid reservoir sections may be interchangeable and each coupleable to the percolator section 220 as required. Accordingly, separate lids for each reservoir section may be provided.

### The Exploded View:

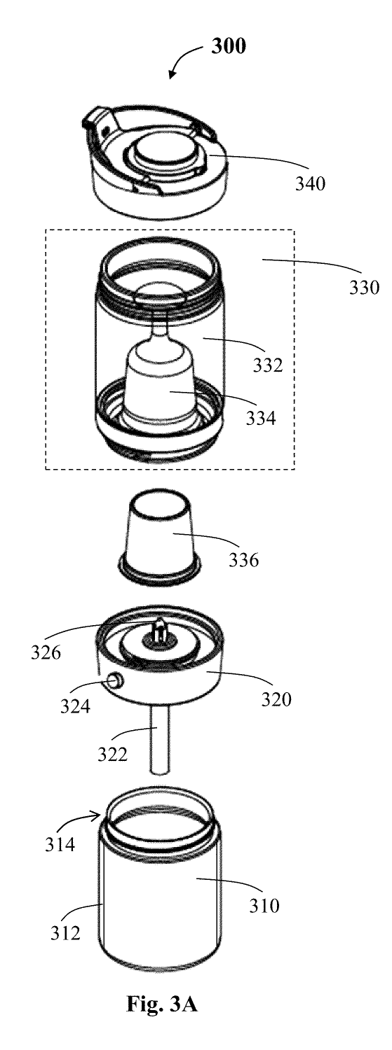

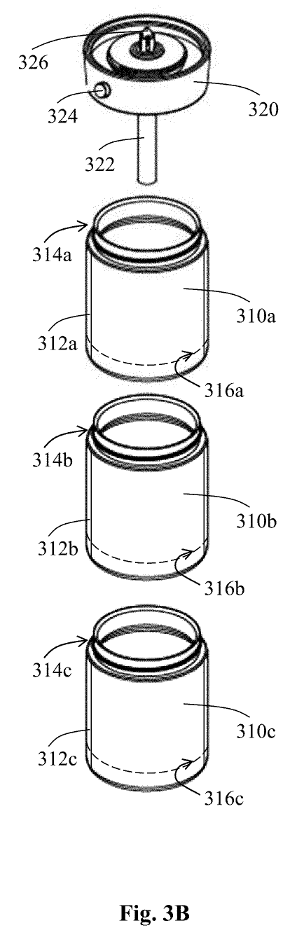

Reference is now made to FIG. 3A, there is provided an exploded perspective view of the main elements of a portable drinks percolator, which is generally indicated at 300, for preparing a desirable beverage (coffee, tea, and the like), according to one embodiment of the invention. The portable drinks percolator 300 exploded view includes a liquid reservoir section 310 comprising an insulated container 312 suitable for retaining a portion of the liquid coupleable with a flask lid section 320 via a sealable coupling element 314, a percolator section 330 coupleable with the flask lid section 320 and the upper cap assembly section 340 via another coupleable sealing mechanism as described in FIGS. 4A-B and FIG. 5A.

The flask lid section 320 further includes a flask flow tube 322 extending through the flask lid section into the liquid reservoir section 310, a puncture pin 326 configured to puncture the beverage capsule 336 at its lower side; a sealing element 324 (see FIG. 4B, item 416) operable to allow air passage into the lower internal space at the top of the liquid reservoir section 310, via a body sealable aperture (see FIG. 4B, item 422 to form the pressure differential.

The percolator section 330 further includes a beverage receptacle reservoir section 322 suitable to contain the beverage and a capsule housing 334 configured to hold the beverage capsule of the desired beverage.

Alternatively, as shown in FIG. 3B, multiple liquid reservoir sections 310a-c may be configured to interlock into a chain, for example by providing an internal sealing coupling mechanism 316a-c to the underside of the wall 312a-c of each liquid reservoir configured to couple with a corresponding coupling mechanism 314a-c of the next liquid reservoir section. Accordingly, each liquid reservoir sections 310a-c may serve to seal the next.

### The Flask Lid Section:

FIG. 4A and FIG. 4B provide various illustrations of the flask lid coupleable with the liquid reservoir section. FIG. 4A represents a schematic perspective view and FIG. 4B represents a cross sectional view as indicated in FIG. 4A.

Reference is now made to FIG. 4A, there is provided a schematic perspective illustration of the main elements of the flask lid associated with the portable drinks percolator, which is generally indicated at 400A, for use with the liquid reservoir section, according to one embodiment of the invention. The flask lid 400A includes a flask lid body 410, a flask flow tube 412 extending through the flask lid section into the liquid reservoir section (FIG. 3A, item 310), a puncture pin 414 configured to puncture the beverage capsule (FIG. 3A, item 336) at its lower side, a sealing button element 416 configured to allow air into the lower internal space at the top of the liquid reservoir section (FIG. 3A, item 310) to form the pressure differential. The flask lid 400A is coupleable with the percolator section (FIG. 3A, item 330) via another coupling element 418A.

Reference is now made to FIG. 4B, there is provided a schematic cross sectional illustration of the main elements of the flask lid associated with the portable drinks percolator, which is generally indicated at 400B, for use with the liquid reservoir section, according to one embodiment of the invention. The flask lid 400B includes a flask lid body 410, a flask flow tube 412 extending through the flask lid section into the liquid reservoir section (FIG. 3A, item 310), a puncture pin 414 configured to puncture the beverage capsule (FIG. 3A, item 336) at its lower side having slots 414A at the sharp edge to enable flow of liquid into the beverage capsule (FIG. 3A, item 336), a button 416 configured to allow air via the air slot 422 into the lower internal space 432 to form the pressure differential, pressing the liquid of the liquid reservoir section (FIG. 3A, item 310) onto the flask flow tube 412. The flask lid 400B is coupleable with the percolator section (FIG. 3A, item 330) via a coupling element 418A and further coupleable with the liquid reservoir section (FIG. 3A, item 310) via another coupling element 418B. The flask lid 400B further includes a flat sealing ring 424 to avoid liquid leakage through the coupling element 418A. Similarly, the flask lid 400B may further include another flat sealing ring to avoid liquid leakage through the coupling element 418B.

### The Percolator Section:

Reference is now made to FIG. 5A, there is provided a perspective view schematic illustration of the main elements of a percolator section of the portable drinks percolator, which is generally indicated at 500A, and for preparing a desirable beverage, according to one embodiment of the invention. The percolator section 500A perspective view includes a beverage capsule housing 520, a percolator tube housing 530 and a base coupling unit 524. It is noted that the percolator section 500A may be coupled with a beverage receptacle wall 510 to form the beverage receptacle reservoir section 122.

The beverage receptacle wall 510 includes an upper coupling mechanism 512 at its top side configured to couple with the upper cap assembly section (FIG. 3A, item 340) to form the upper internal space.

The base coupling unit 524 includes a body and an associated coupling mechanism, as described in FIG. 5B.

The beverage capsule housing 520 includes an housing body, at least one puncture pin, a non-return valve and a beverage flow tube, as described in FIGS. 5B-C.

The percolator tube housing 530 includes at least one capsule puncture pin and a flow tube extending through the flask lid section into the liquid reservoir section and a spout cover extending into the coffee receptacle reservoir section, as described in FIGS. 5B-C, hereinafter.

Reference is now made to FIG. 5B, there is provided a perspective schematic illustration of the main elements of the percolating mechanism, which is generally indicated at 500B, for preparing a desirable beverage, according to one embodiment of the invention. The percolating mechanism illustration 500B includes a base coupling unit 524, a beverage capsule housing 520, a percolator tube housing 530 and a spout cover 540.

It is noted that the base coupling unit 524, the beverage capsule housing 520, the percolator tube housing 530 and a spout cover 532 may be manufactured as an integrated unit using molding technology, for example. Alternatively, various elements of the percolating mechanism may be manufactured separately and attached together, thereafter. The spout cover 540, for example, may be manufactured as a detachable component to facilitate better cleaning of the tube beverage flow slots.

The base coupling unit 524 comprises an integrated body having a coupling mechanism comprising a first coupler 528A and a second coupler 528B. The base coupling unit 524 is configured to couple with the beverage receptacle reservoir section (FIG. 5A, item 510) via the first coupler 528A, and further to couple with the flask lid (FIG. 4A-B, item 410) via the second coupler 528B. It should be appreciated that the described coupling mechanism is presented by way of a non-limiting example, and may be used variously. For example, the first coupler may be omitted, if the beverage receptacle reservoir section (FIG. 5A, item 510) is manufactured as an integrated unit with the percolating mechanism

A beverage capsule (FIG. 3A, item 336) may fit into the beverage capsule housing 520, shaped accordingly. For example, a K-Cup® capsule (trademarked to Keurig Green Mountain) having a trapezoidal shaped beverage capsule may be used, according to the current embodiment, placed such that the beverage capsule is directed with the wider shape downwards. Such K-Cup® capsule provides for a single-serve brewing capsule. Additionally or alternatively, K-Cup® capsule compatibles may also be used.

It should be appreciated that the current embodiment, having a capsule housing of a trapezoidal shaped cross-section is presented as non-limiting example and other shaped capsule may be available, using an appropriate beverage capsule housing.

As appropriate, other shapes/dimensions of beverage capsules may be used, requiring a matching capsule housing. Additionally or alternatively, the capsule housing may be manufactured as a detachable component. Similarly, coffee pads may be also used with an appropriate coffee pad housing.

The housing flow tube 530 and the spout cover 540 extending into the coffee receptacle reservoir section are further described in FIG. 5C.

It is noted that various type of beverage capsules may be used with the portable drinks percolator, such as capsules for coffee, tea, vegetarian drinks and the like.

Reference is now made to FIG. 5C, there is provided a cross-sectional schematic illustration of the main elements of the percolating mechanism, which is generally indicated at 500C, for preparing a desirable beverage, according to one embodiment of the invention. The percolating mechanism schematic illustration 500C includes a base coupling unit 524, a beverage capsule housing 520, a percolator tube housing 530 and a spout cover 540.

The base coupling unit 524 comprising an integrated body having a coupling mechanism comprising a first coupler 528A and a second coupler 528B, as described in FIG. 5B, hereinabove.

The beverage capsule housing 520 is configured to accommodate beverage capsules having a trapezoidal cross section, with specific dimensions, used with K-Cup® capsule, for example and other compatible capsules. It is noted that other capsules may be used and the capsule housing may need to change accordingly.

The percolating mechanism further includes the housing flow tube 534 extending into the beverage receptacle reservoir section (FIG. 5A, item 510) having a non-return valve 536 configured to prevent beverage flow downwards, at least one puncture pin 532 configured to puncture the upper side of a beverage capsule (FIG. 3A, item 336) and the spout cover 540 extending into the receptacle reservoir section (FIG. 5A, item 510), with an associated beverage slots 542 configured to direct the beverage flow into the beverage receptacle reservoir section (FIG. 5A, item 510).

### The Upper Cover Assembly Section:

Reference is now made to FIG. 6, there is provided a schematic exploded perspective view illustration of an upper cap assembly section, which is generally indicated at 600, representing the main elements of the an upper cap assembly coupleable with the beverage receptacle reservoir, according to one embodiment of the current disclosure. The exploded view of the upper cap assembly section 600 includes an upper cap assembly 610 comprising an air extraction mechanism operable to pump out the air contained within the upper internal space formed when coupling the upper cap assembly onto the percolator section and a beverage receptacle reservoir 620 of the percolator section.

The upper cap assembly 610 includes an upper cap body 612, an air extraction mechanism 614 and a closure lid 616.

The upper cap body 612 includes an upper cap base element 612a, an upper cap lip 612b comprising a hinge slot 612f (only one is shown), a closure ring 612c and a sealable outlet 612d comprising a drinking aperture 612e to facilitate drinking or pouring the contained beverage. As appropriate, the closure ring 612c is operable to secure the air-extracting mechanism 614 within the air-extracting chamber (not shown).

Optionally, the drinking aperture 612e of the sealable outlet 612d is further configured to accommodate a drinking straw when the closure lid is open and disengaged, for example. Alternatively, the upper cap lip 612b of the sealable outlet facilitates direct drinking therefrom, when the closure lid is disengaged. Additionally, the sealable outlet 612d may include a spout to facilitate pouring of the beverage therefrom, when in the closure lid is disengaged.

The air-extracting mechanism 614 is operable to pump out the air contained within the upper internal space of the portable drinks percolator created between upper cap assembly 610 and the beverage receptacle reservoir section (FIG. 3A, item 332) of the percolator section (FIG. 3A, item 330). The air-extracting mechanism 614 is configured, for example, to generate linear motion of the extraction plunger 614b by the activator 614a, activated manually by a user and further pushing the air out through the upper cap assembly section.

The closure lid 616 is configured to clip onto the upper cap lip 612b by a “U” shaped locking element 616d to tightly cover the drinking aperture 612e of the sealable outlet 612d, when the closure lid 616 is engaged (closed position). Additionally, the closure lid 616 is operable to change state, rotating over the hinges 616b and 616c to disengage. As appropriate, to enable drinking, the “U” shaped locking element 616d needs to be flipped over to unlock the cover lid 616 from the upper cap lip 612b and uncover the drinking aperture to allow air into the upper internal space and to facilitate drinking or pouring.

It is particularly noted that the closure lid 616 further comprises a sealing element (not shown, see FIG. 4A item 418) which further comprises an air-tight seal configured to prevent leakage of air into the upper internal space, when closure lid 616 is engaged.

It is a feature of the current disclosure that the upper cap assembly 610 is an integrated unit incorporating the air-extracting mechanism 614 as an intrinsic component. Such an integrated unit is distinctive from a container from which air may be extracted with an external air-extracting mechanism unconnected to the upper cap.

In still other embodiments, where necessary the upper cap assembly 610 may be adapted such that it may be readily dismantled by the user, possibly for cleaning or the like. In such an embodiment the intrinsic air-extracting mechanism 614 may be disassembled when necessary.

The upper cap body 612a is further coupleable with the beverage receptacle reservoir section 622 via a coupling mechanism 626 to form the upper internal space with the receptacle reservoir section 622 is further coupled, such as illustrated in FIG. 5A, into the percolator section. The coupling mechanism 626, as shown in this embodiment, is a threaded coupler and is presented by way of example only, in a non-limiting manner.

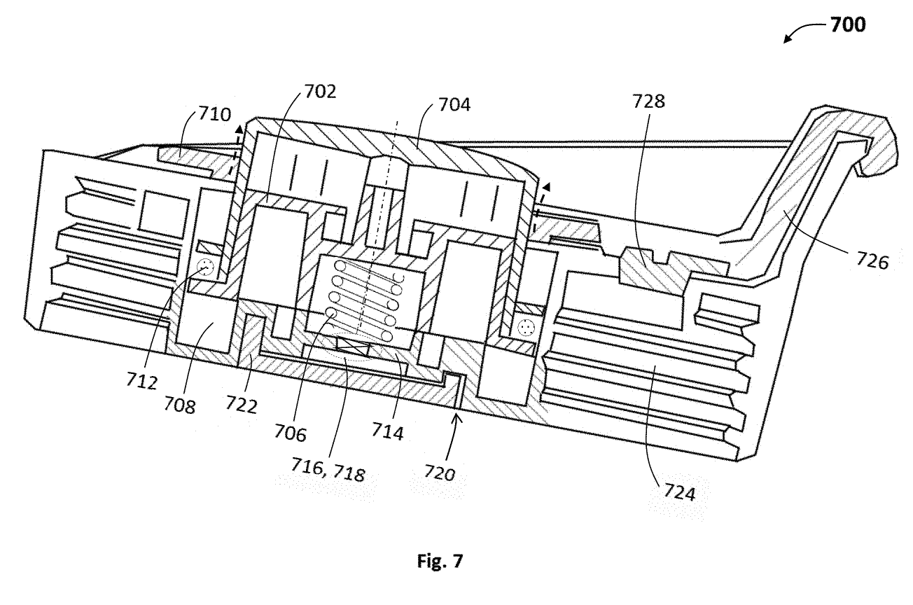

Reference is now made to FIG. 7, there is provided a schematic cross section illustration of the upper cap assembly section, which is generally indicated at 700, including the main elements of the air-extracting device, according to an embodiment of the current disclosure. The air-extracting device 700 is operable to extract air from a sealable container space (FIG. 2, item 222) The air-extracting device 700 includes an air-extracting mechanism comprising an extracting plunger 702, an activator 704 and a mechanical spring 706 incorporated into an air-extracting chamber 708.

The air-extracting chamber 708 includes a closure ring 710, a rubber sealing ring 712, an internal spring support 714, an aperture 716 cut through the internal spring support 714 and the bottom of the air-extracting chamber 708, and a non-returning valve 718 configured to fit into the aperture 716. The air-extracting chamber 708 further includes at its lower part at least one suction nozzle 720 and a bottom cover 722. The mechanical spring 706 is positioned between the internal side of the extracting plunger 702 and the internal support 716 which may be attached to the air-extracting chamber 708.

The air-extracting mechanism is operable to pump out the air from the sealable container space (FIG. 2, item 222) through the air inlet holes 720 via the aperture 716 into the space of the air-extracting chamber 708 and pushed further, out through the circumference of the extracting plunger 704, as indicated by the dotted line.

It is noted that the non-return valve is operable to allow one-directional air flow from the upper internal space (FIG. 2, item 222) into the space of the air-extracting chamber 708 only.

It is further noted that the bottom cover 722 is configured to cover the air inlet holes 720 to avoid clogging of the air passage through the inlet holes.

It is noted that the schematic cross section illustration of the upper cap assembly section further includes the sealable coupling mechanism 724, the closure lid 726 and the sealing element 728.

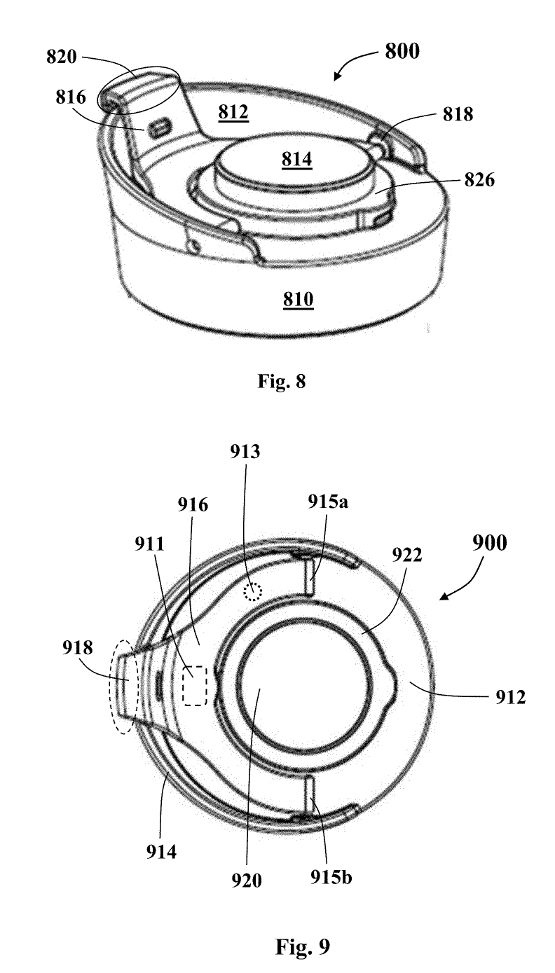

Reference is now made to FIG. 8, there is provided a perspective view schematic illustration of an upper cap assembly section, which is generally indicated at 800, of according to an embodiment of the current disclosure. The upper cap assembly section perspective view 800 includes an upper cap body 810, an upper cap lip 812, an air-extracting activator 814 and a closure lid 816 rotatable over two hinges 818 and configured to be in a locked position in which the sealing element (not shown, beneath the closure lid 816) that may seal the drinking aperture (FIG. 6, item 612e).

The closure lid 816 comprises a “U” shaped locking element 820 configured to lock the closure lid 816 onto the upper cap lip 812 and provide a safe seal of the upper cap assembly section 800. As appropriate, a closure ring 822 is configured to position securely an air-extracting mechanism (not shown) onto the upper cap body 810. The air-extracting mechanism is configured to extract air from within the upper internal space created by coupling the upper cap assembly section 800 with the receptacle reservoir section (FIG. 5A, item 510) provide pressure differential such that the beverage can be prepared. The air-extracting mechanism is operable by pressing on the activator 814, possibly generating linear motion of an extraction plunger pumping out the air. As appropriate, the closure ring 822 is configured to position securely the air-extracting mechanism onto the upper cap assembly body 810.

It is noted that the schematic perspective view of the upper cap assembly section 800 is representing the closure lid 816 engaged (closed position, ready for preparing the beverage) after extracting the air from the upper internal space and the plunger activator 822 is in its lower position.

Reference is now made to FIG. 9, there is provided a top view schematic illustration of an upper cap assembly section, which is generally indicated at 900, according to an embodiment of the current disclosure.

The top view illustration 900 of the upper cap assembly section, provides the details of the upper cap assembly and includes the upper cap base element 912, the upper cap lip 914, the closure lid 916, the “U” shaped locking element 918, the activator 920 of the air extraction mechanism (FIG. 6, item 614) and the closure ring 922. The closure lid 916, shown in a closed position and clicked onto the upper cap lip 914 by the “U” shaped locking element 918.

The closure lid 916 is further operable to change position to an open position, rotating over the hinges 915a and 915b. When in open position, the aperture (FIG. 6, item 612e) is exposed allowing air into the drinkable container to facilitate drinking or pouring the beverage of the container via the upper cap lip 914. The closure lid 916 further comprises a sealing element (not shown) to provide an air-tight container when the closure lid 916 is engaged (in closed position).

The closure ring 922 is operable to position the air-extracting mechanism in the associated air-extracting chamber (not shown) incorporating the extracting plunger and other associated elements of the mechanism.

It should be appreciated to those skilled in the art that the invention may not be limited to the details of the foregoing illustrative embodiments and that the present invention may use various other embodiments in other specific forms without departing from the nature or essential attributes thereof. The present embodiments are therefore to be considered in all respects as illustrative and not restrictive.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

1. A portable drinks percolator for making a beverage comprising:
a liquid reservoir section for retaining a portion of a liquid, said liquid reservoir section containing a first internal space;
a percolator section comprising a beverage receptacle reservoir section configured to receive beverage infused liquid percolated through a beverage capsule; and
an upper cap assembly section coupleable with the beverage receptacle reservoir section thereby forming a second internal space, said upper cap assembly section comprising an air-extracting device operable to extract air from the second internal space,
wherein said portable drinks percolator is operable to create a pressure differential between the second internal space and the first internal space thereby driving the liquid from the liquid reservoir section through the beverage capsule into the beverage receptacle reservoir section.

2. The portable drinks percolator of claim 1, wherein said upper cap assembly section further comprises a sealable liquid outlet and a lip to facilitate drinking therefrom.

3. The portable drinks percolator of claim 1, wherein said percolator section further comprises:
a housing for said beverage capsule, said beverage capsule having a first face and a second face;
at least one capsule puncture pin configured to puncture the first face of the beverage capsule;
a housing flow tube comprising a spout cover extending into the beverage receptacle reservoir section, said housing flow tube operable to allow flow through the beverage capsule onto the beverage receptacle reservoir section through at least one slot of the spout cover.

4. The portable drinks percolator of claim 3, wherein said housing flow tube comprises said at least one capsule puncture pin.

5. The portable drinks percolator of claim 3, wherein said percolator section further comprises a non-return valve to prevent beverage leakage into the liquid reservoir section.

6. The portable drinks percolator of claim 3, wherein said liquid reservoir section comprises a flask lid section comprising:
a flask flow tube extending through the flask lid section into the liquid reservoir section;
a second puncture pin configured to puncture the second face of the beverage capsule; and
a body sealable aperture comprising a first sealing element operable to allow air passage into the first internal space at the top of the liquid reservoir section to form the pressure differential.

7. The portable drinks percolator of claim 6, wherein said body sealable aperture uses a sealing mechanism operable to disengage the first sealing element, said sealing mechanism selected from a group including of: a push button, a sealing ring, a sealing handle and combinations thereof.

8. The portable drinks percolator of claim 7, wherein said pressure differential is generated by activating the air-extracting device to extract air from the second internal space and further allowing outside air into the first internal space via said sealing mechanism thereby activating beverage percolation.

9. The portable drinks percolator of claim 7, wherein said first sealing element comprises an air-tight seal made of a rubberized material configured to fit tightly into the body sealable aperture.

10. The portable drinks percolator of claim 1, wherein said upper cap assembly section comprises:
an upper cap body comprising said lip and an air-extracting chamber configured to incorporate said air-extracting device;
a sealable outlet having an outlet sealable aperture and a second sealing element; and
a closure lid secured onto the lip and operable to cover tightly the outlet sealable aperture.

11. The portable drinks percolator of claim 10, wherein said closure lid further comprises:
at least one hinge attached to said upper cap body enabling said closure lid to rotate thereabout, and further to disengage from the outlet sealable aperture and thereby uncovering the outlet sealable aperture to allow air access to enable drinking.

12. The portable drinks percolator of claim 10, wherein said second sealing element comprises an air-tight seal of a rubberized material configured to fit tightly into the outlet sealable aperture.

13. The portable drinks percolator of claim 2, wherein said air-extracting mechanism comprises an extracting plunger, an activator and a mechanical spring configured such that the activator is operable to activate the extracting plunger against the mechanical spring thereby generating linear motion to evacuate air from the second internal space.

14. The portable drinks percolator of claim 1, wherein said insulated container comprises a double wall having an inner wall and an outer wall configured to inhibit conduction of heat from the first internal space.

15. The portable drinks percolator of claim 1, wherein said insulated container comprises a double vacuum insulated wall having an inner wall and an outer wall forming a vacuum seal configured to inhibit conduction of heat from the first internal space.

16. The portable drinks percolator of claim 1, wherein said insulated container comprises a wall of a material selected from a group consisting of: a transparent material, an opaque material and combinations thereof.

17. The portable drinks percolator of claim 1, wherein said liquid reservoir section comprises a wall of a material selected from a group consisting of: a transparent material, an opaque material and combinations thereof.

18. The portable drinks percolator of claim 1, wherein said liquid reservoir section comprises a flask lid section comprising a flask lid body comprising a coupling mechanism with at least one rubberized sealing ring.

19. The portable drinks percolator of claim 18, wherein said coupling mechanism is configured to couple the flask lid section said liquid reservoir section.

20. The portable drinks percolator of claim 18, wherein said coupling mechanism is configured to couple the flask lid section with said percolator section.
